(19) United States
(12) Patent Application Publication
(10) Pub. No.: US 2012/0227000 A1
(43) Pub. Date: Sep. 6, 2012

(54) METHODS AND SYSTEMS FOR USE IN PROVIDING CUSTOMIZED SYSTEM MENUS

(75) Inventors: Charles McCoy, Coronado, CA (US); Leo Pedlow, Ramona, CA (US); Ling Jun Wong, Escondido, CA (US); True Xiong, San Diego, CA (US)

(73) Assignees: SONY NETWORK ENTERTAINMENT INTERNATIONAL LLC, Los Angeles, CA (US); SONY CORPORATION, Tokyo (JP)

(21) Appl. No.: 13/077,969

(22) Filed: Mar. 31, 2011

Related U.S. Application Data
(60) Provisional application No. 61/448,797, filed on Mar. 3, 2011.

(51) Int. Cl. G06F 3/01; G06F 15/16

(52) U.S. Cl. 715/762

(57) ABSTRACT

Some embodiments provide methods of distributing system menus, comprising: receiving a request, from over a distributed network, to communicate a system menu to a requesting consumer electronic (CE) device; identifying the CE device; identifying a user interface corresponding to the CE device; identifying a system menu intended to be utilized by the CE device, wherein the system menu comprises a plurality of menu items with each menu item associates with a function; and communicating the identified system menu to the CE device.

### CROSS-REFERENCE TO RELATED APPLICATIONS

This application claims the benefit of U.S. Provisional Application No. 61/448,797, filed Mar. 3, 2011, for McCoy et al., entitled “METHOD AND APPARATUS FOR PROVIDING CUSTOMIZED MENUS”, Attorney Docket No. 450103-06504, which is incorporated in its entirety herein by reference.

### Related Applications

This application is also related to co-pending application number ______, to McCoy et al., entitled “CUSTOMIZABLE SYSTEM MENU (OR XMB) FOR IPTV DEVICES”, (Attorney Docket No.______), filed on the same day as this application, the entire disclosures of which are incorporated herein by reference.

### BACKGROUND

1. Field of the Invention

The present invention relates generally to user interfaces, and more specifically to displayed menus.

2. Discussion of the Related Art

Consumer electronic (CE) devices are readily available. Many manufacturers distribute their CE devices throughout the world. Some of these CE devices include a display that displays information and/or options. These options can be used to interact with the CE device.

### SUMMARY OF THE INVENTION

Several embodiments of the invention advantageously address the needs above as well as other needs by providing customizing and distributing system menus. Some embodiments provide methods of distributing system menus, comprising: receiving a request, from over a distributed network, to communicate a system menu to a requesting consumer electronic (CE) device; identifying the CE device; identifying a user interface corresponding to the CE device; identifying a system menu intended to be utilized by the CE device, wherein the system menu comprises a plurality of menu items with each menu item associates with a function; and communicating the identified system menu to the CE device.

Other embodiments provide methods of customizing system menus. Some of these methods comprise: identifying a system menu, the system menu comprising a plurality of menu items with each menu item corresponding to a different function configured to be implemented in response to selection of the menu item by an end user when the system menu is displayed by a consumer electronic device; receiving a selection of a first menu item of the plurality of menu items; receiving instructions to modify dimensions of the first menu item when displayed; identifying, in response to the instructions to modify the dimensions of the first menu item, a first plurality of the base cells to merge in defining modified dimensions of the first menu item; and merging the first plurality of base cells and defining the modified dimensions of the first menu item.

Some embodiments provide a computer program product comprising a medium for embodying a computer program for input to a processor based system and a computer program embodied in the medium configured to cause the processor based system to perform steps comprising: receiving a request, from over a distributed network, to communicate a system menu to a requesting consumer electronic (CE) device; identifying the CE device; identifying a user interface corresponding to the CE device; identifying a system menu intended to be utilized by the CE device, wherein the system menu comprises a plurality of menu items with each menu item associates with a function; and communicating the identified system menu to the CE device.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 shows a simplified block diagram of a representative system menu according to some embodiments.

FIG. 2 shows a simplified block diagram of a system menu according to some embodiments.

FIG. 3 shows a simplified block diagram of an alternative configuration of a system menu.

FIG. 4 shows a simplified block diagram of a system menu according to some implementations.

FIGS. 5A-5C depict simplified bock diagram representations of user interfaces, according to some embodiments, that further illustrate one or more base cell grids or matrices within which a system menu can be configured.

FIG. 6 depicts a simplified flow diagram of a process of customizing a system menu, according to some embodiments.

FIG. 7 depicts a simplified flow diagram of an example of a process according to some embodiments of customizing and/or modifying a system menu.

FIG. 8 depicts a simplified flow diagram of a process in distributing system menus to relevant CE devices.

FIG. 9 depicts a simplified flow diagram of a process of registering a CE device with a menu service or server.

FIG. 10 depicts a simplified block diagram of a system configured to provide the customization and distribution of system menus according to some embodiments.

FIG. 11 illustrates a system for use in implementing methods, techniques, devices, apparatuses, systems, servers, sources and the like in customizing, distributing and/or using system menus in accordance with some embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” “some embodiments,” “some implementations,” or similar language means that a particular feature, structure, or characteristic described in connection with the embodiment is included in at least one embodiment of the present invention. Thus, appearances of the phrases “in some embodiment,” “in some implementations,” and similar language throughout this specification may, but do not necessarily, all refer to the same embodiment.

Methods, systems and apparatuses are provided for use in allowing system menus for different consumer electronic (CE) devices to be customized and distributed over one or more distributed networks to the CE devices after the CE devices are manufactured and shipped. A system menu is received, stored and maintained at the CE device to be used at the CE device in controlling the operation, parameters, settings and/or operation of the CE device. Typical CE devices have user interfaces and system menus that are fixed and hard coded into firmware at the time of manufacturing and cannot be changed that defines the system menu and its appearance. Alternatively, present embodiments provide system menus that can readily be customized and distributed over a distributed network, such as the Internet, to CE devices after the CE devices are manufactured and distributed to customers. System menus are top level menus that are fundamental parts of the main user interface of CE devices, unlike menus that can be obtained and displayed in a web application that is run on a CE device, and in some instances the system menus are globally accessible on the CE device. Further, the system menus can be modified over time and redistributed to CE devices.

Accordingly, business needs and logistics can be addressed with the customization of system menus. For example, a business entity can register a plurality of CE devices with a menu service or servers, and designate that the registered CE devices are collectively part of the business entity. Further, the business entity can request customization of the system menus to address business desires, needs and logistics. When one of these registered CE devices access the menu service the menu service can identify the CE device, such as through unique CE device identifications (ID) that is typically hard coded or otherwise burned in the CE device. Once the CE device is identified the menu service can further determine that the CE device is associated with the business entity and distribute a customized system menu to the CE device that is customized in accordance with the request of the business entity. This can provide consistency throughout a business entity, allow for improved user experiences, provide a system menu with more relevance to the business entity and other such benefits. For example, a hotel chain may request customization of system menus to be delivered to the CE devices within the hotels to provide more consistency over the CE devices, provide functionality and/or emphasize functionality more relevant to the hotel, improve users' experiences and other such benefits. Further, through the distribution of system menus the manufacturers of CE devices can greatly reduce the number of product lines because specific product lines do not have to be established for different customers, for different regions of the world to comply with regional regulations, laws or preferences, and the like, as more fully described below.

Each customized system menu has a layout that defines a structure of the system menu and sub-menus as well as defines relative positioning of menu items relative to each other within the system menu when displayed by a CE device. In many embodiments the layout is defined from a series, matrix or grid of base cells. A base cell defines a fundamental two-dimensional area when displayed, and is the smallest common denominator of the system menu, the system menu layout, the sub-menus and the menu items of the system menu. Similarly, the base cell is the smallest division of display real estate that can be specified by the menu definitions. Through the merging of neighboring base cells the system menu and menu items are readily designed, configured and customized.

In some embodiments, the system menu layout and each menu item and/or element of the system menu layout are defined as whole number multiples of the base cell. As such, a displayed area occupied by the system menu, sub-menu and the menu items is defined as a number of base cells. The width and height of the system menu, system menu layout and menu items of the system menu are defined as whole number multiples of the width and height, respectively, of the base cell. Additionally, a width and height of the system menu, system menu layout, sub-menus and/or menu items when displayed are restricted to and are not smaller than the width and height, respectively, of a single base cell. Further, displayed two-dimensional areas of displayed menu items are defined as being equal to a single base cell or configured from the merging of two or more base cells. The use of the base cell can additionally allow for the customization of system menus for different user interface types for different types of CE devices.

In some implementation, the base cell is defined as a particular number of pixels wide and high depending on the user interface of the CE device, with different base cell sizes often used for different CE devices. The size of the base cell can be substantially any relevant size and defined by substantially any relevant number of one or more pixels. The cell size for a particular user interface type is fixed and typically does not vary by such things as screen size. This allows images to be built that are the specified size of the menu item. In some embodiments, menu items may have a variable display size that could be based on, for example, the CE device's rendering of text to be displayed in the menu item. Additionally or alternatively, the widths of menu items could be normalized or limited. For example, menu items may be normalized so that they are defined to be at least the smallest size that would accommodate a particular sized text (e.g., the largest text). This normalization could be done across one or more, or all menu items within the same menu or sub-menu or could be done across specified groupings of menu items. Similarly, in some implementations the normalization could be used in a traditional menu style that has an icon followed by a text label for each menu item.

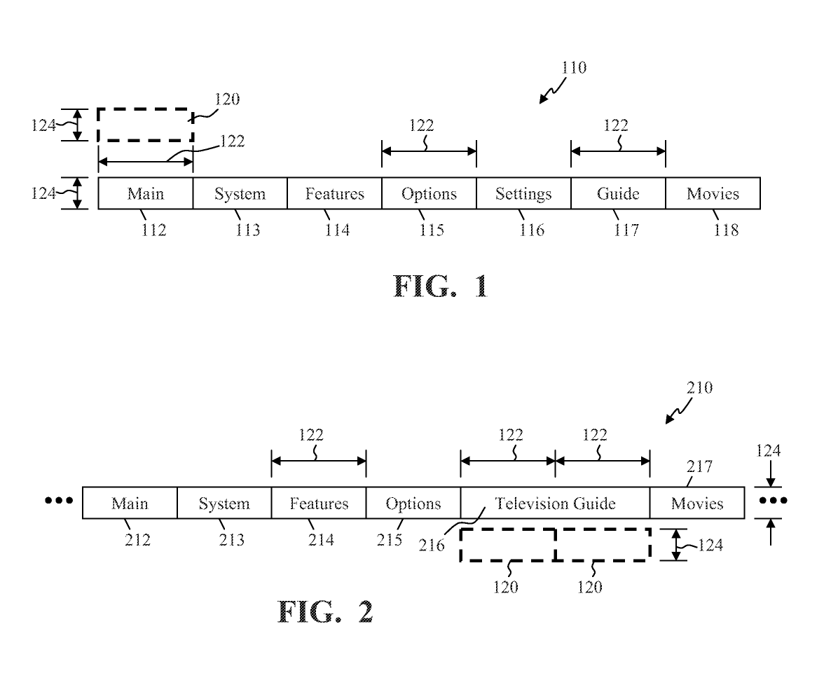

FIG. 1 shows a simplified block diagram of an example of a system menu 110 according to some embodiments. The system menu 110 includes a plurality of menu items 112-118. As introduced above, the dimensions of the displayed system menu 110 and the menu items 112-118 are defined as whole number multiples of a base cell 120. In this example, each menu item 112-118 is defined with dimensions equal to a single base cell 120, and thus has dimensions equal to one (1) base cell width (or length) 122 and one (1) base cell height 124 (e.g., a (1×1) multiplier of the base cell). The base cell 120 can have substantially any relevant size, and typically is defined as a function of the user interface and/or display resolution of the CE device intended to receive and display the system menu configured according to the base cell.

The layout of the system menu 110 is similarly configured according to the base cell 120. In this example, the system menu 110 is configured with a height equal to one base cell, while it has a width or length dimension that is seven (7) times the base cell width 122. In configuring the system menu 110 substantially any number of menu items 112-118 can be included in the system menu 110. Further, the menu items 112-118 are associated with one or more functions that are activated in response to detecting a user highlighting, selecting, hovering a pointer or otherwise indicating the menu item. As described above and further below, the system menu 110 is customizable as a function of the base cell 120 through the merging of base cells in defining sizes of menu items.

FIG. 2 shows a simplified block diagram of an alternative configuration of a system menu 210 according to some embodiments. The system menu 210 includes a plurality of menu items 212-217. In this implementation, the Television Guide menu item 216 is configured by merging two (2) base cells 120. Accordingly, the Guide menu item 216 has a width of two (2) times the width 122 of the base cell 120, while having a height equal to the height 124 of one (1) base cell 120 (e.g., a (2×1) multiplier of the base cell 120). The merging of base cells to customize a menu item can allow for greater information to be provided, draw attention to and/or emphasize the menu item, make it easier to identify and/or access, and other such benefits. Substantially any number of base cells can be merged to define a system menu item, sub-menu or the menu. Some embodiments, however, apply limits to the merging as described below.

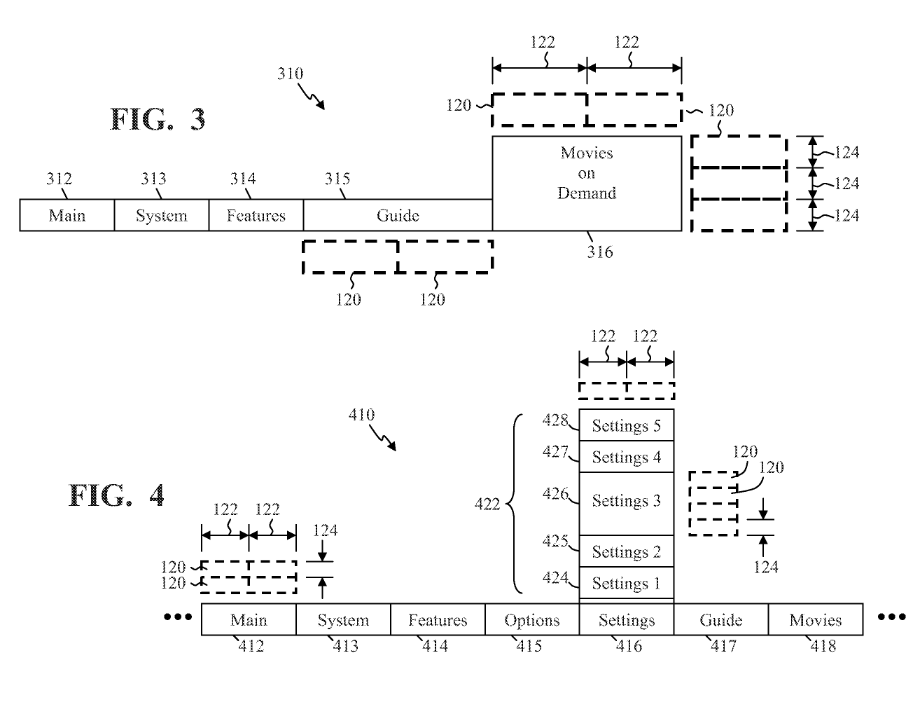

FIG. 3 shows a simplified block diagram of an alternative configuration of a system menu 310, according to some implementations. The system menu 310 includes a plurality of menu items 312-316. In this implementation the Guide menu item 315 is defined by the merging of two base cells according to a 2×1 (width×height) multiplier of the base cell 120. The Movies on Demand menu item 316 is defined by the merging of six (6) base cells 120 according to a 2×3 multiplier of the base cell, resulting in a width equal to two (2) times the width 122 of the base cell 120, and a height equal to three (3) times the height 124 of the base cell 120. Accordingly, in some embodiments the customization can vary within the system menu and/or sub-menus, where not all of the menu items at the same level have to be the same size. This can be used to provide more emphasis to a menu item and/or make a menu item more important (e.g., by defining a menu item's size through the merging of two or more base cells 120, and in some instances take up two or more “positions” in the system menu or sub-menu).

FIG. 4 shows a simplified block diagram of a system menu 410 according to some implementations. The system menu 410 includes a plurality of main menu items 412-418 that are customized by merging four base cells 120 according to a 2×2 multiplier. As introduced above, the menu items 412-418 can be associated with functions to be implemented by the CE device displaying the system menu 110. Some embodiments provide for a sub-menu 422 to be displayed as a function associated with a menu item, such as the Settings menu item 416 in FIG. 4. Again, the activation of the function associated with a menu item can be in response to a selection of the menu item, highlighting the menu item (e.g., moving a highlighting indicator over the menu item 416, hovering a pointing device or indicator over the menu item 416, or the like) or otherwise indicating to the CE device to activate the function corresponding to the menu item.

The sub-menu 422 also includes one or more menu items 424-428. Again, the sub-menu 422 and menu items 424-428 of the sub-menu are similarly defined according to whole number multiples of the base cell 120. In this example, the menu items 424-428 of the sub-menu 422 have a width of two (2) times the width 122 of the base cell 120. The height of menu items 424-425 and 427-428 are similarly equal to two (2) times the height 124 of the base cell 120 (e.g., a (2×2), width×height, multiplier of the base cell). The height of the “Settings 3” menu item 426 has a modified height equal to four (4) times the height of the base cell 120 (e.g., a (2×4), width x height, multiplier of the base cell). As described above, in some embodiments the customization can vary within the system menu and/or sub-menus, where not all of the menu items at the same level or in the same sub-menu have to be the same size.

Accordingly, system menus, sub-menus and the menu items are readily configurable by modifying multiplier factors for a given system menu, sub-menu and/or menu items and merging base cells 120 to achieve desired menu configurations. The merging of base cells 120 can be used to emphasize one or more menu items, provide greater information about a function associated with a corresponding menu item, or the like. Further, the dimensions of the base cell 120 are often defined according to the user interface and/or display characteristics of the CE device intended to display the system menu. As such, when a CE device accesses a menu service or server over a distributed network the menu service can identify an interface type of the CE device requesting a system menu, and based at least in part on the identified interface type select an appropriate system menu configured for the interface type. The base cell 120 of the selected system menu is appropriately sized relative to the interface type of the CE device so that the system menu is effectively and/or optimally displayed. Similarly, the base cell 120 and the cells merged for given menu items further define the dimensions of a highlighting, distinguishing or other indication that a user is hovering over a menu item, has selected a menu item, has transitioned from one menu item to a next menu item, and other such indications.

In accordance with some embodiments, the base cell size is defined as a function of the user interface type, which can be determined by the screen resolution of the CE device. Further, a menu definition may in some instances be utilized across multiple user interface types, which in some implementations may be accomplished by having menu images that are appropriate for the largest cell size. Based on resolution a scaling can be applied, such as half of the largest cell size then a CE device that displays a smaller image could produce an appropriately sized smaller image by scaling the larger image. Alternatively, separate menu images are defined for different user interface types, which may be beneficial in some instances because of reduced network bandwidth, memory usage, and CPU cycles to download an image that is larger than needed and then scale it to the desired size. In some embodiments, the menu definitions can include the links or URLs for each size image, and/or a menu server or service distributing the menu definitions can know what user interface type the requesting CE device is using and include the URLs for the appropriately sized images in the response.

The base cell 120 provides the foundation upon which the system menu, sub-menus and menu items are configured. In some embodiments, a grid or matrix of base cells is provided within which the system menu, sub-menu and/or menu items can be positioned, with the merging of base cells to establish the system menu, sub-menu and menu items.

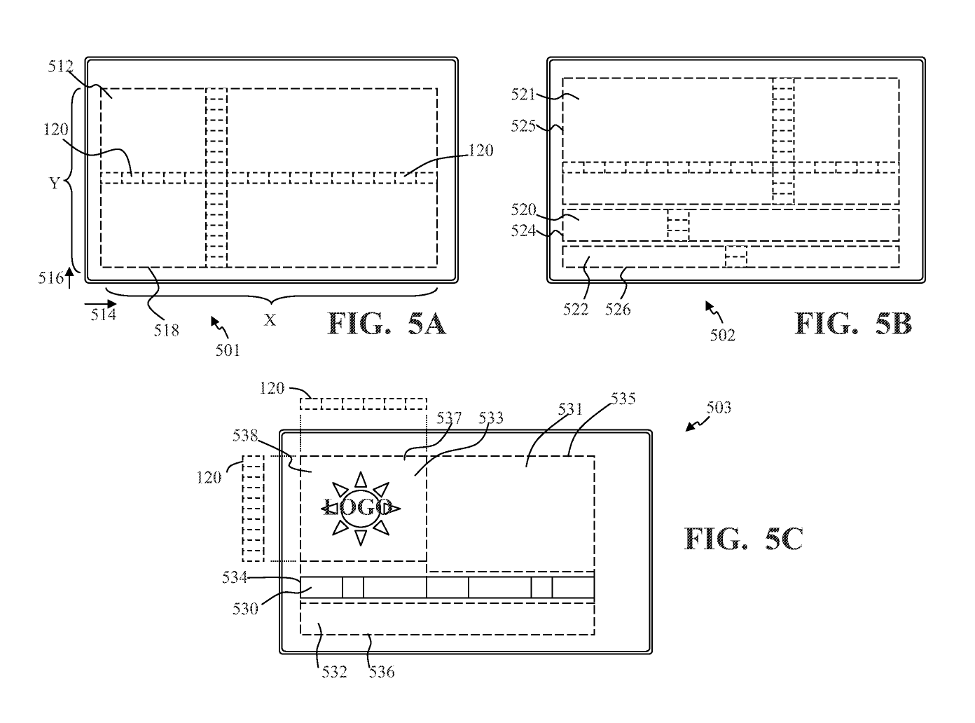

FIGS. 5A-5C depict simplified bock diagram representations of user interfaces 501-503 according to some embodiments, that further illustrate one or more base cell grids or matrices within which a system menu can be configured. In some embodiments, one or more base cell or grid boundaries may be defined. A system menu, sub-menus and/or menu items when displayed may be limited to being within these boundaries. In other embodiments, the system menu, sub-menus and/or menu items may extend beyond the boundaries but may not be displayed until a user causes a transition of the system menu and/or sub-menu, such as a scrolling using a mouse, track ball, other pointing device, arrow keys or other relevant navigating devices or commands.

Referring to FIG. SA, a single base cell grid 512 is shown having X base cells 120 along a first dimension 514 (e.g., horizontal relative to the display) and Y base cells 120 along a second dimension 516 (e.g., horizontal). A system menu can be configured from the base cells 120 and the merging of base cells. The system menu when displayed is displayed within the base cell grid 512. It is noted that in some instances a length or height of the system menu and/or sub-menus may be greater than the base cell grid 512, and in effect appear to extend beyond the base cell grid 512 with those menu items beyond the boundaries 518 of the base cell grid 512 not being displayed until a user causes a transition of the system menu and/or sub-menus, such as through a scrolling.

FIG. 5B shows three base cell grids 520-522 with corresponding boundaries 524-526, respectively. In some instances, a system menu (e.g., system menu 110 of FIG. 1) may be restricted to a certain area or zone of the display of the CE device, such as a first grid 520. Similarly, in some instances sub-menus (e.g., sub-menu 422) may be restricted to one or both the second grid 521 and/or third grid 522. Again, in some instances, a system menu 110 and/or sub-menu 422 may extend beyond the boundaries 524-526 with menu items outside the boundaries not being displayed until a user causes a scrolling or the like. Further, the scrolling may result in a looping of menu items instead of merely reaching an end of the system menu and an end menu item. In other embodiments, the boundaries in one direction (e.g., vertically) may restrict the system menu, sub-menu and/or menu item from exceeding that boundary, while the boundaries in the perpendicular direction (e.g., horizontally) may be exceeded. As an example, the a boundary 524 may restrict a system menu 110 from having a height that exceeds the top and bottom of the boundary 524 while the system menu may appear when displayed to extend beyond the sides of the boundary 524.

FIG. 5C shows a third configuration similar to the configuration of FIG. 5B, where there are three base cell grids 530-532 with corresponding boundaries 534-536. In this example, however, a fourth area 538 is provided. This area may be designated for menu items or non-menu items. For example, in some instances, the fourth area 538 may be designated for graphics, images, video, broadcast content playback (e.g., picture-in-picture) or the like. As another example, the fourth area 538 could be used to show information associated with the menu item that currently has focus, such as detailed description text or an image. Typically, this fourth area 538 is similarly defined according to whole number multiplier factors of the base cell 120 (e.g., a (6×10) multiplier). In other instances, however, the fourth area 538 may not be part of the system menu, with base cell grids 530-532 instead being configured around the fourth area 538 with the system menu and sub-menus being displayed without interfering with the fourth area 538.

With the use of the base cell 120 the customization of system menus is simplified. Further, the customization is readily applied to different CE devices having different user interfaces. Again, a base cell is defined relative to a user interface of a CE device. As such, in defining a layout of a system menu according to base cells and the merging of base cells a single system menu configuration can be applied to and displayed by multiple different user interface types while displaying system menus proportional to and in accordance with characteristics of the CE displaying the system menu. This can significantly reduce time in generating and/or customizing a system menu as well as distributing the system menu.

As described above, the system menu is maintained and distributed by a menu service or server. In some implementations, the menu service further provides the CE device with access to content, information and/or other relevant content or data. For example, the menu service can be provided by and/or operated under the control of the BRAVIA Internet Video Link (BIVL) service provided by Sony Corporation. Customers can cooperate with the menu service to request system menu customization. In some instances, the menu service may provide and/or allow a customer to access an application or user interface that allows the customer to define at least some of the system menu customization. For example, a customer can identify a certain menu item in a system menu or a specific sub-menu and request that the menu item be customized (e.g., through the identification of a base cell multiplier, such as X×Y base cell multiplier). In other instances, the customer may remove, add or move menu items, change links or functions associated with menu items, change text and/or information displayed relative to a menu item, and other such customization. Accordingly, in some implementations the menu definitions may be under the control of a menu service, but that service may still give a customer or user control to make customizations.

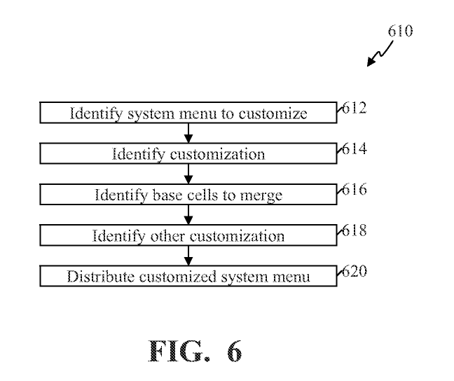

FIG. 6 depicts a simplified flow diagram of a process 610 of a menu service customizing a system menu. In step 612, a system menu to be customized is identified. This identification can be based on a customer identification (e.g., through a customer log-in), a CE device identification, a customer selection of a system menu, a selection of a system menu template, a selection of default system menu, or other such identification or combinations of such identifications. For example, in some instances a customer may establish and maintain a customer account with a menu service. When the customer is logged-in the menu service can identify system menus previously associated with the logged-in customer. Accordingly, the menu service can display a listing of system menus associated with the customer.

In other instances, the menu service may identify one or more CE devices that have been associated with the logged-in customer. In response to identifying the CE devices the menu service can identify system menus corresponding to the CE devices. Further, in some embodiments, multiple system menus may be selected, such as when the multiple system menus have some common configuration. Additionally, the customization, in some instances, may be limited to those common configurations when multiple different system menus are selected.

In step 614, the customization to be applied to the selected system menu is identified. In some instances, a menu service creates a system menu, such as in response to a product release or identification of a new CE device. Similarly, a menu service may modify and/or customize a system menu based on additional features, adding one or more menu items (e.g., changes in partnerships, such as with content providers), moving one or more menu items (e.g., based on tracked use or user input), removing menu items, and/or other such customization. Additionally, in some embodiments, a customer can request and/or identify customization to be made. For example, a customer may identify a system menu and request a new menu item be incorporated, request that a menu item be modified (e.g., increased in size so that the menu item is more visible), select size of a menu item from a listing of options for menu items, select “show” or “hide” option associated with a potential menu item that may be incorporated into the identified system menu, or other such customizations.

In step 616, one or more base cells to be merged are identified and merged such that menu definitions define the modified system menu, sub-menu and/or menu item(s). Again, the system menu, sub-menus and/or menu items are configured according to base cells 120, and their relative size and area upon being displayed are defined relative to whole number multipliers of the base cell 120 in defining a relative height and width of the system menu, sub-menu and menu items.

In step 618, other customization that may be relevant are identified and applied. For example, in some instances, graphics may be modified and/or incorporated, images and/or icons may be defined, modified and/or incorporated, and/or other such customization may be applied. In some instances, some of these additional customizations may be dependent on the area defined by the base cell, and multipliers of the base cell are defined. For example, when incorporating graphics into a system menu and/or to be cooperated with a system menu a graphics area may be defined with displayed height and width defined as whole number multiples of the height and width, respectively, of the base cell 120. Again, the graphics area can incorporate notices, text, image, video, advertising, coupons, and substantially any other relevant information. Similarly, a customer may designate a theme (e.g., holiday theme), select graphics to incorporate around menu items, incorporate additional information (e.g., hotel guests name, information about the hotel facility, and like), and other such customization.

In step 620, the customized system menu is distributed and/or the modified menu definitions are distributed. As described above, a menu service or server(s) distributes the customized system menu over a distributed network to one or more CE devices. In some instances, the CE devices initiate access over the distributed network to the menu service. The menu service identifies the CE device and then identifies that the customized system menu is intended to be utilized by the CE device. As such, the menu service communicates the customized system menu or modified menu definitions to the CE device. The CE device in turn locally stores the system menu, in some instances replacing a previous system menu or applied as a modification to an existing menu, for subsequent use when the CE device and/or user activates the customized system menu. In some instances, an existing system menu being replaced or modified may be preserved at the CE device and/or the menu service to allow the CE device to revert back to the previous system menu.

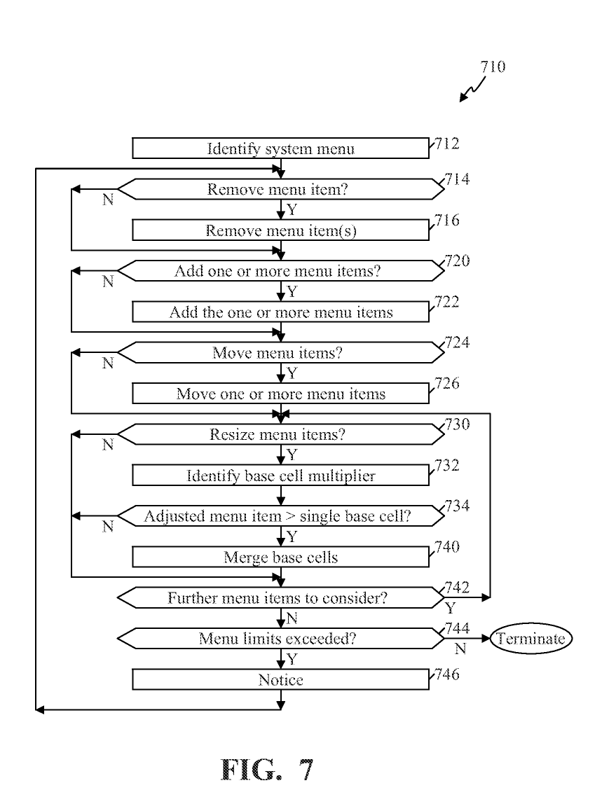

FIG. 7 depicts a simplified flow diagram of an example of a process 710 according to some embodiments of customizing and/or modifying a system menu. In step 712, a system menu is identified. The identification can result from an administrator of the menu service selecting one or more system menus, based on a selection or other identification by a remote customer, or other such identification. For example, a customer may be identified and based on the identification of the customer the system menu associated with that customer may be identified. In other instances, a customer may be identified and in response multiple system menus associated with that customer may be identified, and a listing can be provided to the customer to select one or more of the system menus (e.g., the listing can be titles; group name of a group of CE devices or groups of CE devices associated with the system menu; icons, such as icons established by customer; graphic images of the displayed system menus; displaying system menus and allowing the customer to transition between displayed system menus to identify one or more; and other such identifications). Further, in some instances, a new system menu may be created. In this instance step 712 may identify a system menu template, identify a base cell grid to allow the grid to be populated with menu items, and the like. As a result of identifying the system menu to be customized some embodiments may display a working version of the system menu for visual aids in customizing.

In step 714, it is determined whether to remove one or more menu items. This can be based on designations received from a customer and/or an administrator of the menu service identifying one or more menu items to delete. In some instances, a sub-menu can be deleted by the selection to delete a menu item that activates the sub-menu. When one or more menu items are not to be removed the process 710 continues to step 720. Step 716 is entered when one or more menu items are to be removed and the identified menu item or items are removed. The process 710 may return to step 714 to determine whether further menu items are to be removed or may advance to step 720. As part of removing the menu items, the system menu can be adjusted accordingly, in some embodiments, to consolidate menu items.

In step 720, it is determined whether to add one or more menu items. Again, the administrator or a customer may request a menu item be added. For example, the request to add a menu item may be based on a selection of potential available menu items, based on a defined function, or other such menu item identification. When a menu item is to be added the process continues to step 722 to add the one or more menu items. In some instances, the administrator or customer can identify a location where the menu item is to be incorporated (e.g., by a drag-n-drop; specifying a location in a base cell grid (e.g., designation a location of the menu item, a bottom left corner of a menu item, or the like); replacing an existing menu item; or other such designations. In some instances, remaining menu items are adjusted based on the added one or more menu items when relevant.

In step 724, a determination is made regarding whether to move one or more menu items. Again, an administrator or in some instances a customer can perform a drag-n-drop, or other such designation of a destination location. When a move is not to be preformed the process advances to step 730. Alternatively, step 726 is entered where the one or more menu items are moved, and in some implementations the remaining menu items are adjusted when relevant.

In step 730, it is determined whether one or more menu items are to be resized. As described above, the menu items can be resized based on the base cell. When a menu item is not to be resized the process 710 advances to step 742. In response to determining that one or more menu items are to be resized step 732 is entered to identify a horizontal whole number multiplier of the base cell and vertical whole multiplier of the base cell. In some instances an administrator merely enters the multipliers (e.g., 3×3). Some embodiments allow a corner of a selected menu item to be dragged and upon release an identification of a nearest position within a base cell grid for the dragged corner is identified, which in some implementations can be used to identify relevant base cell multipliers.

In step 734, the multipliers are evaluated to determine whether the one or more adjusted menu items are greater than a single base cell. When a menu item is defined as being greater than a single cell step 740 is entered to merge horizontal multiplier number of base cells and the vertical multiplier number of base cells at the designated position to define the dimensions of the adjusted menu item. Following the base cell merging or when merging is not to be preformed the process continues to step 742 where it can be determined whether there are further menu items to be considered and/or defined. For example, it can be determined whether the menu service administrator identified or selected another menu item to be modified, whether customer has identified further menu items or the like. When one or more further menu items are to be considered the process returns to step 730 (or optionally, step 714, 720 or 724 if further modifications may be performed).

Some implementations may apply limits to sizes of the system menu, sub-menus and/or menu items. As such, further steps may be included to evaluate the menu items and/or the system menu to determine whether limits or boundaries are exceeded. For example, the process 710 may include optional steps 744 and 746 to evaluate the resulting system menu relative to display limits and/or boundaries. For example, step 744 can evaluate one or more of the system menu, sub-menus and/or menu items to determine whether the system menu exceeds menu limits, item limits and/or boundaries. When the system menu, sub-menus and/or menu items satisfy limits and restrictions the system menu is saved and the process may terminate. Alternatively, when boundaries and/or limits are exceeded that cannot be exceed the process issues an error in step 746, which can include a notification of the error identifying one or more problems. In some instances the process may return to step 714 to remove one or more menu items, or optionally to step 732 to redefine a size of one or more menu items. The customization may further allow an administrator and/or customer to incorporate graphics, text, define coloring and other such modifications. Still further limitations may apply to these customizations. For example, some menu items may have designated text, graphics and/or icons (e.g., menu item to link to a service available on the Internet, such as a site that distributes video content), and as such restrictions may apply regarding what modifications can be applied.

System menus, in some embodiments, may be configured to additionally or alternatively provide for dynamic creation of menu items by a CE device itself in modifying a system menu. For example, one or more menu items of a system menu can be defined as parent menus that have predefined identifiers that allow the CE device to identify parent menus into which the CE device can incorporate one or more dynamically generated menu items. In some instances, a CE device may generate its own parent menu and add that to a top level system menu to add dynamic menu items to the system menus. Naming restrictions may be applied in attempts to avoid names of the dynamically generated menus that may not be correlated with the system menu definitions and/or duplicate naming of different menus and/or menu items. For example, a dynamically generated menu item may be generated in response to detecting an insertion at the CE device of a memory card, USB storage device or the like that contained media files. The CE device may add one or more items to a system menu to allow a user at the CE device to navigate to and access (e.g., play back) content from the memory card or other storage. Similarly, the CE device may add one or more menu items for content that may be available over a network connection.

Additionally, some embodiments are configured to use the same menu definitions for multiple CE devices. Accordingly, CE devices may identify and not display one or more menu items when the one or more menu items are associated with an action the CE device can not perform, a menu item is not relevant to a CE device, when a menu item is a parent menu with no items to show in the parent menu item, or the like. For example, a menu definition can include a “3D Settings” menu item. When this menu definition is distributed to multiple different CE devices (e.g., multiple different TVs), then those CE devices that are have 3D settings will display the “3D Settings” menu item. Similarly, a “video” menu, for example, can be included in a system menu that is an empty parent menu. The empty “video” menu will not be displayed unless a dynamic menu item is added to it by the CE device. In some instances, this mechanism can also be used to provide context sensitive menu items, such as an item to mark a TV channel as a favorite, which would not be shown when there was no TV channel tuned, for example, when an external input is selected.

Further, the distribution of system menus can equally be applied to substantially any relevant CE device configured to receive system menus. This can include CE devices that are not capable of displaying a graphical user interface. For example, a system menu can be distributed to an audio receiver that can only display text (e.g., display three lines of text on a front panel display), but does not output a video signal. Accordingly, this same method for defining and distributing system menus can be used with such a CE device. Additionally, as further described blow, system menus can be defined relative to a global or geographic location and/or region in which a CE device is located and connects to a distributed network. This can allow, for example, a CE device to receive menu items for content that is available in a country in which the CE device is located, while another CE device located in another country may receive menu items relative to a rating scheme that is used in that country. As such, a single type of CE device can be manufactured for both markets and still have menus customized to the region where the CE device is used.

In some instances, the a working version of the adjusted system menu can be displayed and/or displayed on a designated CE device with a user interface intended to receive the customized system menu (e.g., directed by the menu service to a specific CE device that was previously identified by a customer and visible to the customer as the customization and modifications are requested). The working version may be displayed in response to each modification, displayed following a completion of the customization or at other points during the customization.

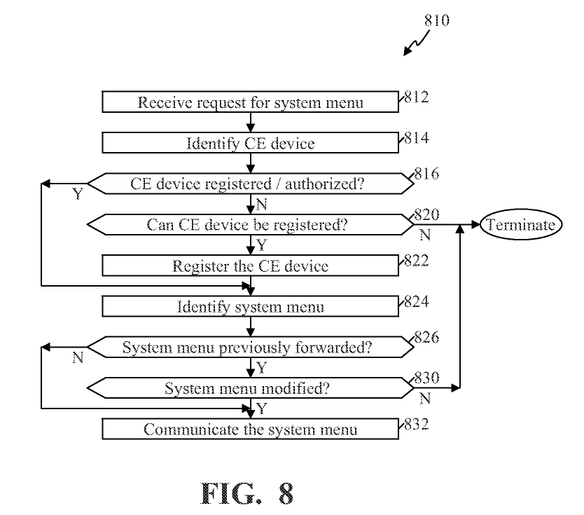

FIG. 8 depicts a simplified flow diagram of a process 810 in distributing system menus to relevant CE devices. Again, the distribution of the customized system menus is over a distributed network such as the Internet, other wide area network (WAN), local area network (LAN), or other such network or combinations of such networks. The menu service receives a request and/or registration of a CE device and distributes a relevant system menu to authorized CE devices. In step 812, a request is received for the distribution of a relevant system menu. In step 814, the requesting CE device is identified. The information to identify a CE device may be included with the request, be identified by a customer or through other methods. For example, the CE device may include a unique device identification that distinguishes the CE devices from other CE devices. In some instances the CE device identification is globally unique to the CE device and distinguishes the CE device from all other devices.

In step 816, it is determined whether the CE device is registered and/or otherwise authorized to receive the system menu. In some instances, a CE device does not have to be registered to receive a system menu. Alternatively, an authorization to distribute one or more system menus to a requesting CE device can be based on an identification of a CE device, information provided by the CE device, whether a pass code or the like is provided, an identification of a network location and/or address, whether the CE device is associated with a group or customer, and/or other such information. When the CE device is registered or authorized the process advances to step 824. Alternatively, step 820 is entered to confirm that the CE device can be registered (e.g., the first time a CE device accesses the menu service). For example, the menu service can verify that the CE device is authorized to take advantage of services of the system and/or menu service. When the CE device cannot be registered the process terminates. In those instances where the CE device can be registered step 822 is entered where the CE device is registered.

In step 824, a system menu is identified that is associated with the CE device. The identification of the system menu can be dependent on one or more factors, such as but not limited to, registration information retained at the menu service; based on a menu identification provided by the CE device (e.g., the CE device may have obtained the menu identification when registered and/or upon receiving updated or otherwise customized system menu); a profile of the CE device that is retained by the menu service or supplied by the CE device (again, a profile could be generated by the menu service and forwarded to the CE device, and/or updated and re-forwarded); a type of CE device; a model number of a CE device; customizations registered and/or associated with a CE device and/or type of CE device; whether the CE device is associated with one or more groups (e.g., part of a hotel chain); selected by a customer (e.g., a limited number of menus may have been provided as options to a customer based on the CE device and other factors as described above and further below); or other such factors and/or combinations of such factors.

Additionally, in some embodiments, those actions associated with menu items of the system menu and/or those menu definitions that the CE device can utilized or effectively implement are identified. Again as described above, a system menu may be configured for multiple CE devices, and may defined menu items associated with actions that the requesting CE device may not be able to implement. Accordingly the system menu and/or menu definitions forwarded to the requesting CE device may be limited to those items and/or menu definitions that can be utilized, implemented and/or recognized by the requesting CE device.

In step 826, it is determined whether the identified system menu was previously forwarded to the CE device. When the system menu was previously forwarded step 830 is entered to determine whether the system menu has been modified, customized or updated since the system menu was last delivered. For example, in some instances, a log file or other method of tracking modifications can be maintained. Other information may additionally be tracked such as, but not limited to, the distribution of a system menu, to which CE devices a system menu was distributed, when the system menu was distributed, updates to the system menu, when updates were made and/or other such information. In other instances, a version number or the like can be maintained with the system menu and updated when the system menu is modified or otherwise changed. Further, the version number may be forwarded with the system menu when communicated to the CE device, and the CE device can return the version number when a system menu was previously received and/or communicated by the CE device with an identification of the system menu previously received by the CE device.

In those instances where the CE device already has the most current system menu the process 810 terminates. When the system menu was not previously delivered and/or was modified the process 810 advances to step 832 to communicate the system menu, to communicate the modified system menu, or to communicate modifications to the system menu that are to be incorporated by the CE device (e.g., communicating menu definitions).

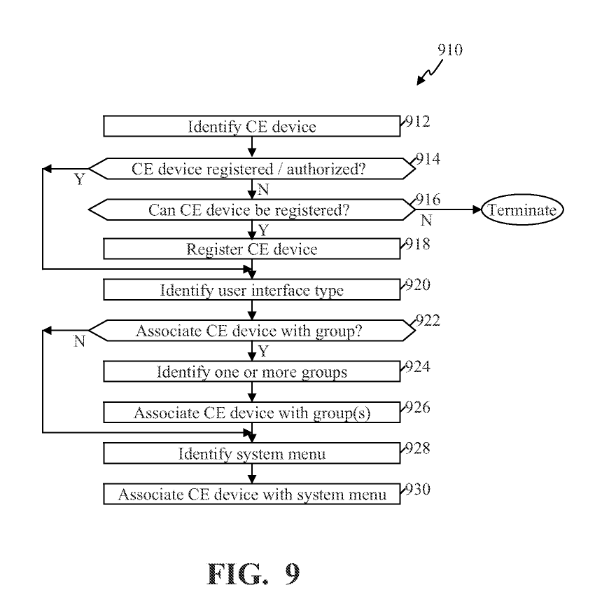

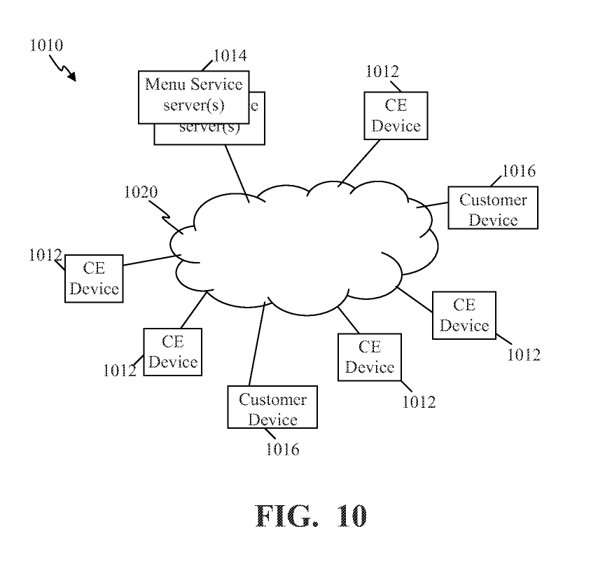

FIG. 9 depicts a simplified flow diagram of a process 910 of registering a CE device with a menu service or server. In step 912, the CE device is identified. As described above, the identification can be based on a unique device identification supplied by the CE device or a customer, or other such identification. In step 914, it is determined whether the CE device is registered with a menu service. When it is determined that the CE device is registered the process advances to step 920. When the CE device is not registered the process 910 continues to step 916 to confirm that the CE device can be registered and take advantage of services provided by the menu service. In those instances where the CE device cannot be registered the process terminates.

When the CE device can be registered step 918 is entered where the CE device is registered with the menu service, which can include obtaining information about and/or from the CE device, such as but not limited to a device ID (e.g., a globally unique ID), network connection capabilities and/or bandwidth, association with a customer, and other such information. In step 920, a user interface (UI) type of the CE device is identified. The user interface type can be identified based on the CE device identification; provided by the CE device (e.g., in response to a request from the menu service); identified by a customer, and/or other information provided, which may be obtained as an exchange between the menu service and the CE device, and/or from the customer.

In step 922, it is determined whether the CE device is to be associated with one or more customers, groups and/or sub-groups (referred to below generally as groups). For example, in some instances, a CE device may be associated with one of two or more product lines for the CE device. Similarly, the CE device may be identified as a specific model of the CE device (e.g., there may be a high-end model, a middle model and a low-end model; or other such models). Further, the CE device may be identified as being in a location that may have restrictions and/or be associated with different parameters, laws, regulations or the like (e.g., a location where the CE device is being operated may be identified from an network address, provided by a customer or otherwise identified), and may be grouped according to the location, such as a country location group. Further still, the CE device may be part of an organization or company and should be grouped relative to that organization or company. Still other groupings may be applied. For example, further groupings within a company or organization may be specified. As one particular example, when it is identified that the CE device is associated with a hotel chain, further groups may be defined relative to that hotel chain grouping, such as but not limited to grouping based on facilities or location, on a specific floor, in a specific wing, room type or designation (e.g., rooms for families; rooms for rewards members; upgraded room; suite; theme (bridal suite); or the like). Substantially any type and/or size grouping can be provided. The different groupings can dictate at least in part what system menu is to be distributed to the CE device.

The identification of whether or not the CE device should be associated with a group and/or which groups the CE device should be associated can come from one or more sources and or determined by the menu service. For example, information may be obtained from communications from the CE device (e.g., CE device identification that can designate a product line, model, etc.), information provided by a customer (e.g., the customer can specify groupings, the menu service may provide a listing or other designation of groups from which a customer can select, the menu service may allow the customer to create one or more groups, and the like), information obtained from the communication (e.g., IP address), and other relevant information.

When it is determined in step 922 that the CE device is to be associated with a group or other restriction, the process 910 continues to step 924 to identify the one or more groups and/or sub-groups with which the CE device is to be associated. Once the one or more groups are identified step 926 is entered where the CE device is associated with the identified one or more groups. For example, one or more tables of CE devices and/or groups may be established associating CE devices with groups. Additionally or alternatively, a profile may be established for the CE device that identifies the one or more groups. This profile may be maintained (locally and/or remotely) by the menu service, stored at the CE device so that the CE device can forward it to the menu service when requested, or otherwise maintained to be retrieved by the menu service as needed. In some embodiments, a grouping designator may be specified such as
“ProductLine/Model/Country/Company/Facility/Floor/Wing/Family” that can identify one or more groups with which the CE device is associated.

When it is determined in step 922 that the CE device is not associated with a group, and follow step 926 when a CE device is associated with one or more groups, the process continues to step 928 where the system menu is identified that is to be associated with the CE device. Again, the identification of the system menu can be based on the group or groupings; based on registration information retained at menu service; based on a system menu identification provided by the CE device (e.g., the CE device may have previously obtained the menu identification when registered and/or upon receiving updated or otherwise customized system menu); based on a profile of the CE device that is retained by the menu service or supplied by the CE device (again, a profile could be generated by menu service and forwarded to CE device, and/or updated and re-forwarded); an identification of a customer registering the CE device; and other such information or combinations of such information. In step 930, the CE device is associated with the identified system menu. This association can be designated in profile of the CE device, provided as a menu identification to CE device to be retained, incorporated into a table, or other such association or combinations of such associations.

As described above, the CE device may initiate contact with the menu service over a distributed network (e.g., the Internet), and when relevant register with the menu service as an individual CE device. In other instances, as described above, a CE device may be associated with a company, organization or the like that has registered with the menu service and effectively is a customer of the menu service. Typically, the customer wants the CE devices of the customer to be associated with the customer and in some instances associated with other CE devices of the customer. Accordingly, customers often register CE devices with the menu service or otherwise identify CE devices that are to be associated with the customer (e.g., when those CE devices attempt to register themselves the menu service recognizes those CE devices as being associated with the customer). Again, this registration can further associate the CE device with one or more groups and/or sub-groups. This can allow the customer to more fully customize system menus for different CE devices depending on the intended use, location and other factors relevant to the customer.

Further, the ability to customize the system menus that are used by CE devices associated with the customer provides the customer with significant advantages, including but not limited to, maintain consistency, improved performance and may provide branding, while providing features and/or emphasizing functionality more relevant to the intended use, location and/or user of the CE device. For example, a hotel chain may customize system menus based on hotel location, room type, floor of the hotel the CE device is positioned, location within the hotel or resort, whether the room is intended for families, whether the room is intended for business traveler, whether there are special promotions, and other such factors. Similarly, one or more functions and/or functionality may be more readily utilized or have more preference in certain locations or markets. For example, one or more preferences may be emphasized in a first configured system menu for a type of CE device operating in a first market (e.g., music recognition (e.g., through gracenote™), a specific social networking site (e.g.,)facebook® , and/or other preferences), while other functionality or links may be emphasized in a second configured system menu for the same type of CE device operating in a second location and/or market (e.g., closed captioning, a different social networking site (e.g., mixi™), and/or other preferences).

In customizing one or more system menus a customer can coordinate with the menu service in establishing and/or customizing a system menu. In some instances, the customer can coordinate with the menu service via telephone, emails, facsimile, or other such communication. An administrator at the menu service can utilize an administration console and/or interface to specify and customize one or more system menus based on the customer requests, the user interface of the CE device, user interface typing with cell merging, product lines, models, groups and/or other such factors. For example, the administrator console may allow the administrator to select system menus, select from menu templates from which a system menu is to be generated, add, remove or modify menu items, designate base cell multipliers to define numbers of base cells to merge for menu items, select from a plurality of predefined and pre-sized menu items, designate locations of menu items (e.g., based on the base cell grid or grids, drag and drop, or other such designation), add graphics, receive graphics, images, video, audio or the like to be associated and/or incorporated with a system menu, and other such customization.

Additionally or alternatively, the menu service may provide customers with access to a customization interface. For example, once a customer has registered and/or logged into an account corresponding to the customer, the customer may access a customization interface, for example over the Internet. The customization interface may allow the customer to perform one or more actions such as, but not limited to, registering CE devices, associating system menus with CE devices or groups of CE devices, specify groups, identify CE devices to be incorporated into a group, move CE devices between groups, remove CE devices from association with the customer, request customization to one or more system menus, and/or other such actions.

In some instances, the customer may be provided more control and/or input into the customization. In some embodiments, the customization interface may provide the customer with the ability to define customization, select from menu templates, defining a number of base cells to merge for a given menu item (e.g., selecting base cells, a drag box, etc.), designate base cell multipliers to define numbers of base cells to merge for menu items, select from a plurality of predefined and pre-sized menu items, define or select graphics to incorporate, modify color schemes, define or select boarders, define or select appearances and/or shapes of menu items, associate images and/or graphics with menu items, define a graphics or advertising area (e.g., area 538) and upload graphics, images and/or video (e.g., from USB port, from an Internet site such as Digital Living Network Alliance (DLNA), or other source) to be incorporated into the graphics area, and/or other such modifications. Further, in some embodiments, the customer may be able to generate system menus. The generation of system menus may have some restrictions, such as restrictions based on capabilities of intended CE devices and/or functions that must be included within a system menu, which may depend on the CE devices needs, restrictions applied by the menu service and/or other such restrictions and/or requirements.

The level of access and/or the degree to which a customer can implement customization and/or modifications can depend on many factors. For example, less customization capability may be made available to customers that have limited numbers of CE devices associated with the customer, and customers with limited experience in customizing, than larger customers and/or more sophisticated customers. Similarly, a level of service, the availability of customization and/or the level of customization may depend in part on customer account levels, membership fees, number of CE devices associated with a customer, negotiated at a time one or more CE devices are purchased, and other such factors.

FIG. 10 depicts a simplified block diagram of a system 1010 configured to provide the customization and distribution of system menus according to some embodiments. The system includes CE devices 1012, one or more menu services, servers or devices 1014, one or more customer access devices 1016, and a distributed network 1020 providing communication channels or links between two or more of the devices of the system. The CE devices 1012 can be substantially any consumer electronic device configured to access the remote menu service 1014 and acquire a system menu to allow a user to control the CE device and interact with the CE device, such as in playing back multimedia content. For example, a CE device 1012 can be an Internet Protocol (IP) enabled television, an IP enabled Blu-ray player, an electronic gaming device, an audio player, computer, laptop and/or other such consumer electronic devices.

The menu service 1014 is remote from the CE devices 1012 with the CE devices 1012 communicating over the distributed network 1020 with the remote menu service(s) 1014 to obtain a system menu. The menu service 1014 can be implemented through one or more devices that operate independently or collectively. For example, the menu service 1014 may be a collection of servers distributed over the network 1020. The one or more menu services and/or servers 1014 can be implemented through substantially any server, device or collection of devices configured to customize and/or distribute system menus to relevant CE devices 1012. For example, one or more of the menu services 1014 can be servers operating under the BIVL service provided by Sony Corporation.

The customer access devices 1016 similarly couple with the menu service 1014 over the distributed network and are configured to provide a customer with access to the menu service to request customization to one or more system menus, customize system menus, register CE devices, provide graphics, images, audio, video and/or other multimedia that may be incorporated into one or more system menus, manage accounts, define one or more groups, associate CE devices with groups, and/or perform other maintenance and management of distributed CE devices under control and/or owned by the customer.

In some implementations, the CE devices 1012 can be manufactured with information to access the menu service 1014. For example, the menu service 1014 can comprise servers operating under the BIVL service, and the CE devices may be pre-programmed with a link, URL or other information to access the BIVL service or other menu service. The network 1020 can be the Internet, a WAN, a LAN or other such networks or combinations of such networks that are configured to allow communication between devices and the distribution of system menus. In some instances, the customer device 1016 and one or more CE devices 1012 may be cooperated in a LAN while still having access to the distributed network 1020 and the menu service 1014 over the distributed network 1020.

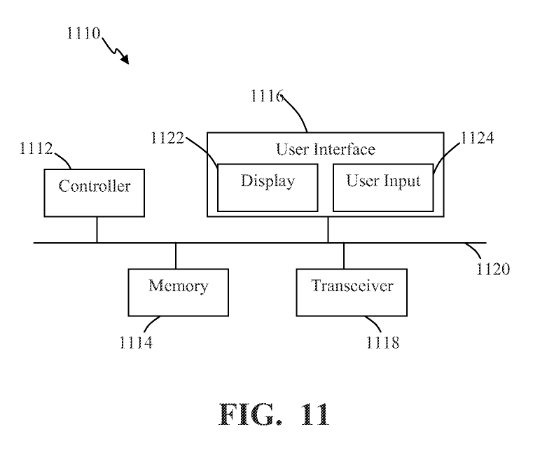

The methods, techniques, devices, services, servers, sources, systems and the like described herein may be utilized, implemented and/or run on many different types of devices and/or systems. Referring to FIG. 11, there is illustrated a system 1110 that may be used for any such implementations, in accordance with some embodiments. One or more components of the system 1110 may be used for implementing any system, apparatus or device mentioned above or below, such as for example any of the above or below mentioned CE devices 1012, remote menu service 1014, customer devices 1016, and the like. However, the use of the system 1110 or any portion thereof is certainly not required.

By way of example, the system 1110 may comprise a controller or processor module 1112, memory 1114, a user interface 1116, and one or more communication links, paths, buses or the like 1120. A power source or supply (not shown) is included or coupled with the system. The controller 1112 can be implemented through one or more processors, microprocessors, central processing unit, logic, local digital storage, firmware and/or other control hardware and/or software, and may be used to execute or assist in executing the steps of the methods and techniques described herein, and control various communications, programs, content, listings, services, interfaces, etc. The user interface 1116 can allow an administrator, customer or user to interact with the system 1110 and receive information through the system. In some instances, the user interface 1116 includes a display 1122 and/or one or more user inputs 1124, such as a remote control, keyboard, mouse, track ball, game controller, buttons, touch screen, etc., which can be part of or wired or wirelessly coupled with the system 1110.

Typically, the system 1110 further includes one or more communication interfaces, ports, transceivers 1118 and the like allowing the system 1110 to communication over the distributed network 1020, other networks or communication channels with other devices and/or other such communications. Further the transceiver 1118 can be configured for wired, wireless, optical, fiber optical cable or other such communication configurations or combinations of such communications.

The system 1110 comprises an example of a control and/or processor-based system with the controller 1112. Again, the controller 1112 can be implemented through one or more processors, controllers, central processing units, logic, software and the like. Further, in some implementations the controller 1112 may provide multiprocessor functionality.

The memory 1114, which can be accessed by the controller 1112, typically includes one or more processor readable and/or computer readable media accessed by at least the controller 1112, and can include volatile and/or nonvolatile media, such as RAM, ROM, EEPROM, flash memory and/or other memory technology. Further, the memory 1114 is shown as internal to the system 1110; however, the memory 1114 can be internal, external or a combination of internal and external memory. The external memory can be substantially any relevant memory such as, but not limited to, one or more of flash memory secure digital (SD) card, universal serial bus (USB) stick or drive, other memory cards, hard drive and other such memory or combinations of such memory. The memory 1114 can store code, software, executables, scripts, data, content, multimedia content, programming, programs, media stream, media files, textual content, identifiers, log or history data, user information and the like. Further, memory 1114 can in some instances store one or more system menus, menu parameters, menu limits, menu conditions, menu restrictions, association of CE devices to system menus, association of user interfaces of CE devices to system menus, CE device profiles, customer profiles, CE device groups, CE device products, CE device product lines, CE device models, CE identification, customer identification, versions, and other such information. In some embodiments, the memory 1114 stores software that implements the system menu customization, system menu utilization, user interfaces, communication protocols and allows one or more administrators, customers and/or users to interact with the system 1110.

One or more of the embodiments, methods, processes, approaches, and/or techniques described above or below may be implemented in one or more computer programs executable by a processor-based system. By way of example, such a processor based system may comprise the processor based system 1110, a computer, IP enabled television, IP enabled Blu-ray player, entertainment system, game console, graphics workstation, tablet, etc. Such a computer program may be used for executing various steps and/or features of the above or below described methods, processes and/or techniques. That is, the computer program may be adapted to cause or configure a processor-based system to execute and achieve the functions described above or below. For example, such computer programs may be used for implementing any embodiment of the above or below described steps, processes or techniques for allowing a CE device 1012 to access a remote menu service 1014 over the distributed network 1020. As another example, such computer programs may be used for implementing any type of tool or similar utility that uses any one or more of the above or below described embodiments, methods, processes, approaches, and/or techniques. In some embodiments, program code modules, loops, subroutines, etc., within the computer program may be used for executing various steps and/or features of the above or below described methods, processes and/or techniques. In some embodiments, the computer program may be stored or embodied on a computer readable storage or recording medium or media, such as any of the computer readable storage or recording medium or media described herein.

Accordingly, some embodiments provide a processor or computer program product comprising a medium for embodying a computer program for input to a processor or computer and a computer program embodied in the medium for causing the processor or computer to perform or execute steps comprising any one or more of the steps involved in any one or more of the embodiments, methods, processes, approaches, and/or techniques described herein. For example, some embodiments provide one or more computer-readable storage mediums storing one or more computer programs for use with a computer simulation, the one or more computer programs adapted to cause a computer and/or processor based system to execute steps comprising: receiving a request, from over a distributed network, to communicate a system menu to a requesting consumer electronic (CE) device; identifying the CE device; identifying a user interface corresponding to the CE device; identifying a system menu intended to be utilized by the CE device, wherein the system menu comprises a plurality of menu items with each menu item associates with a function, and where the system menu is defined according to a base cell where each of the menu items of the system menu has dimensions that are a whole number multiple of the base cell; and communicating the identified system menu to the CE device.

Other embodiments provide one or more computer-readable storage mediums storing one or more computer programs for use with a computer simulation, the one or more computer programs adapted to cause a computer and/or processor based system to execute steps comprising: identifying a system menu, the system menu comprising a plurality of menu items with each menu item corresponding to a different function configured to be implemented in response to selection of the menu item by an end user when the system menu is displayed by a consumer electronic device; receiving a selection of a first menu item of the plurality of menu items; receiving instructions to modify dimensions of the first menu item when displayed; identifying, in response to the instructions to modify the dimensions of the first menu item, a first plurality of the base cells to merge in defining modified dimensions of the first menu item, wherein the dimensions of the one or more of the plurality of menu items are limited to whole number multiples of the base cell; and merging the first plurality of base cells and defining the modified dimensions of the first menu item.

The present embodiments can, in at least some implementations, streamline the manufacture and distribution of CE devices 1012, as well as enhance performance, provide greater flexibility in use and/or information provided to users, maintain the CE devices more current and other such benefits, all while satisfying and/or providing enhanced business advantages and/or logics. Typically, the manufacture and distribution of CE devices can be relatively complex and costly. Different versions of the same CE device typically had to be manufactured to accommodate different factors, such as laws and regulations of different countries. For example, it is common for television manufacturers to manufacture a version of a TV for the United States market, a different version of the TV for the Canada market (e.g., with different ratings codes), a different version of the TV for the Mexico market (e.g., different content licensing), a different version of the TV for the European market, and a different version of the TV for the Japan market. Accordingly, CE manufacturers had several different product lines and had to manage several different inventories. This adds significant costs to the manufacturing and distribution of the CE devices.

Alternatively, some embodiments provide for a single CE device 1012 to be manufactured and distributed. Once the CE device 1012 is put into use it connects over a distributed network 1020, such as the Internet, with a menu service 1014 that identifies the CE device, identifies restrictions and/or parameters relative to the distribution of a system menu (such as but not limited to, location, country, whether the CE is designated as part of a group and other such restrictions or parameters), identifies a relevant customized system menu that meets the restrictions and/or parameters and distributes that system menu over the distributed network to the CE device. The CE device 1012 can then utilize the customized system menu in allowing a user to interact with the CE device, configure the CE device and/or use the CE device. Similarly, CE device manufacturers and/or distributes can take advantage of the customization provided by some embodiments to provide a dynamic menu system with customization user interface typing. Additionally, these customized system menus have little or no maintenance, can save a manufacturer, distributer and/or purchaser of the CE device money from software development and release when a menu item on a CE device is obsolete or changed.

Further, the system menu can be further customized and/or altered over time and redistributed to one or more CE devices. Additionally, menu customization can be implemented for groups and sub-groups of CE devices, such as CE devices owned by a single entity. As such, some embodiment allow customers to customize system menus for CE devices 1012 owned and/or controlled by the customer to satisfy business advantages and/or logistics. The customization can be based on the base cell, the defining of system menus, sub-menus and menu items as multiples of the base cell, the merging of base cells and/or user interface typing.

Furthermore, some embodiments address different user interface types of different CE devices, including different user interface types for different CE devices manufactured by a single company (e.g., multiple types of Sony products). Different CE devices typically have different graphic capabilities, and some CE devices may not support graphical user interfaces. The ability to accommodate different user interface types provided by at least some present embodiments allows some embodiments to extend the distribution of system menus and/or the customization of system menus to some CE devices that do not support graphical interface, such as some CE devices that have text only interfaces (e.g., some audio CE devices), while still supporting CE devices having simple to complex user interface types (e.g., Internet Protocol TV that supports high definition graphical interface and has a higher graphic capabilities). Accordingly, the customized system menus defined in accordance with the base cells support CE devices 1012 with different user interface types.

Some embodiments provide customers with the ability to customize system menus to take advantage of features available to different CE devices while emphasizing to users or viewers services available from the customer. For example, a hotel chain owning thousands to tens of thousands of CE devices capable of taking advantage of the customized system menus, can provide a system menu per CE device and/or product line that takes advantage of each CE device's graphic capabilities while providing a system menu displayed to an occupant of the hotel regarding services available from the hotel and/or emphasizing services, promotions or the like from the hotel. Similarly, a company with multiple offices can provide customized system menus relative to those CE devices owned by the CE devices in the multiple offices.

Additionally, some embodiments satisfy business needs through the ability to customize system menus, in part through the base cell merging and/or menu cells merging. Further customization can allow for the reduction of the number of system menus, sub-menus and/or menu items in a system menu. For example, a business customer might want to merge three base cells into one to define a menu item to provide a better user experience, emphasis, higher accessibility and the like. In another case, a business customer might want to provide both graphical and non-graphical user interface system menus. Some present embodiments provide the ability to customize one or more system menus to accommodate complex CE devices with high resolution graphics, while still providing a customized system menu that can be utilized by a CE device without graphics display capabilities. The functionality provided by some embodiments allows customers to specify and/or customize one or more system menus of different user interface typing and utilize device user interface types, at least in part, to deliver the appropriate system menus to relevant CE devices. Furthermore, the distribution of system menus can be implemented through a predefined resource specifically intended to be accessed by CE devices, and in some instances only CE devices authorized to access the resource. The resource can provide the menu service 1014 and/or direct the CE device to additional resources that provide the menu service.

Some embodiments further allow administrators of the menu service 1014 access to an administration console to specify and customize a system menu, and in some instances customize a system menu user interface typing with cell merging per product lines, models, or groups. Additionally or alternatively, some embodiments may provide a customer interface (e.g., a web accessible interface and/or web site that can be accessed by a CE device owner) that allows CE device owners and/or customers to manage which groups their CE device or devices are in and/or perform other menu customizations. Based at least in part on a CE device's user interface type, the menu service 1014 can provide an appropriate system menu of customized user interface typing. The customization and/or degree to which customization may be implemented depend on the base cell and the size of the base cell. The customization can further vary depending on many factors including, but not limited to, the CE device, the user interface type of the CE device, the menu service capabilities, an account level or status of a customer requesting and/or trying to implement customization and other such restrictions. For example, some restrictions may set limits on a maximum menu item size, which may be based on the base cell size and/or screen size of a particular user interface type. Similarly, some base cells may be non-mergable. For example, a base cell grid may designate some base cells as non-mergable.

Again, some embodiments provide method of customizing and/or configuring a system menu. Some methods comprise: receiving an identification of a first menu item of a plurality of menu items in a system menu, where each of the plurality of menu items is a user selectable item when the system menu is displayed, and each menu item is associated with a different function that is activated upon selection by a user of the corresponding menu item; receiving a designation to merge a first plurality of base cells in defining a length of the first menu item when displayed; receiving a designation to merge a second plurality of base cells in defining a width of the first menu item when displayed; merging the first and second plurality of base cells to define dimensions of the first menu item. Some embodiments further comprise modifying a menu template, where the designation to merge the first and second plurality of base cells is relative to the menu template and the base cell as defined in the menu template.

Other embodiments provide methods for use in configuring system menus. Some of these methods comprise: receiving a selection of a first menu item of a plurality of menu items, where each of the plurality of menu items is a user selectable item when a resulting system menu is displayed and is associated with a different function that is activated upon selection by a user; receiving dimensions of the first menu item comprising a whole number multiplier of the base cell; and merging a number of base cells equal to the whole number multiplier in defining dimensions of the first menu item.

In some embodiments, methods are provided in customizing a system menu comprising: defining a user interface menu structure for a system menu configured for use in setting up parameters of a plurality of different consumer electronic devices having different user interfaces; defining a base cell of the user interface menu structure, where the base cell is a smallest denominator cell of the user interface system menu, and the base cell defines an area within the user interface menu structure when displayed by a consumer electronic devices; defining, within the system menu, a plurality of menu items, where each menu item corresponds with a function configured to be implemented in response to a user selection of the menu item when displayed; and defining dimensions of each of the menu items when displayed in the system menu, where the defining the dimensions comprises defining a whole number multiplier of the base cell and merging a number of base cells equal to the whole number multiplier. Some embodiments additionally or alternatively comprise defining a base cell of a user interface menu structure, where the base cell is not defined as having a fixed display area but instead is defined as an area proportional to a resolution of a display of a consumer electronic device of the plurality of consumer electronic devices displaying a system menu configured according to the user interface menu structure such that an actual area of the base cell when displayed varies depending on which of the plurality of consumer electronic devices is displaying a system menu configured according to the user interface menu structure.

Some embodiments provide methods of customizing a displayed user interface system menu that is to be displayed by a consumer electronic device. These methods comprise: detecting a selection of a first user selectable option of a plurality of user selectable options defined within a default system menu; receiving an instruction to modify a size of the selected first user selectable option; identifying a size to modify the first user selectable option comprising: identifying a whole number multiple that when multiplied by a base cell results in a modified size of a first menu item configured to be selectable by a user, where the base cell is a smallest common denominator displayable area from which each menu item within a resulting system menu is defined such that each menu item within the resulting system menu has a display area that is a whole number multiple of the base cell and is not smaller than the base cell.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of distributing system menus, the method comprising:
receiving a request, from over a distributed network, to communicate a system menu to a requesting consumer electronic (CE) device;
identifying the CE device;
identifying a user interface corresponding to the CE device;
identifying a system menu intended to be utilized by the CE device, wherein the system menu comprises a plurality of menu items with each menu item associates with a function; and
communicating the identified system menu to the CE device.

2. The method of claim 1, wherein the system menu is defined according to a base cell where each of the menu items of the system menu has dimensions that are a whole number multiple of the base cell.

3. The method of claim 2, wherein the communicating the system menu further comprises identifying menu definitions that can be implemented by the identified CE device and only communicating those menu definitions that can be implemented by the CE device.

4. The method of claim 3, wherein communicating the menu definitions of the identified system menu further comprises determining whether the system menu has been modified since the system menu definitions were previously forwarded to the CE device, such that the communicating the menu definitions for the identified system menu comprises communicating only modifications to menu definitions when it is determined the system menu was modified.

5. The method of claim 2, further comprising:
determining, in response to identifying the CE device, whether the CE device is authorized to receive a system menu, and implementing the communicating the system menu to the CE device in response to determining that the CE device is authorized to receive the system menu.

6. The method of claim 2, wherein the identifying the system menu intended to be utilized by the CE device comprises identifying that the CE device is associated with a first group, and identifying the system menu corresponding to the first group.

7. The method of claim 6, wherein the identifying the system menu further comprises identifying the CE device is associated with a second group, and selecting the system menu corresponding to both the first group and the second group.

8. A method of customizing a system menu, the method comprising:
identifying a system menu, the system menu comprising a plurality of menu items with each menu item corresponding to a different function configured to be implemented in response to selection of the menu item by an end user when the system menu is displayed by a consumer electronic device;
receiving a selection of a first menu item of the plurality of menu items;
receiving instructions to modify dimensions of the first menu item when displayed;
identifying, in response to the instructions to modify the dimensions of the first menu item, a first plurality of a base cells to merge in defining modified dimensions of the first menu item; and
merging the first plurality of base cells and defining the modified dimensions of the first menu item.

9. The method of claim 8, wherein dimensions of the plurality of menu items are limited to whole number multiples of the base cell

10. The method of claim 8, wherein the identifying the first plurality of base cells to merge comprises identifying a first whole number multiplier of the base cell defining a width of the modified first menu item.

11. The method of claim 10, within the identifying the first plurality of base cells to merge comprises identifying a second whole number multiplier of the base cell defining a height of the modified first menu item.

12. The method of claim 11, further comprising:
receiving instructions to modify dimensions of a second menu item when displayed;
identifying, in response to the instructions to modify the dimensions of the second menu item, a third whole number multiplier of the base cell in defining the modified dimensions of the second menu item, where the modified dimensions the second menu item is different than the modified dimensions of the first menu item.

13. The method of claim 12, wherein system menu comprises a sub-menu and the second menu item is part of the sub-menu and the first menu item is not part of the sub-menu.

14. The method of claim 8, further comprising:
receiving a designation that the system menu is to be associated with a group of consumer electronic devices; and
communicating the system menu over the distributed network to one or more remote consumer electronic devices associated with the group.

15. A computer program product comprising a medium for embodying a computer program for input to a processor based system and a computer program embodied in the medium configured to cause the processor based system to perform steps comprising:
receiving a request, from over a distributed network, to communicate a system menu to a requesting consumer electronic (CE) device;
identifying the CE device;
identifying a user interface corresponding to the CE device;
identifying a system menu intended to be utilized by the CE device, wherein the system menu comprises a plurality of menu items with each menu item associates with a function; and
communicating the identified system menu to the CE device.

16. A computer program product in accordance with claim 15, wherein the system menu is defined according to a base cell where the system menu and each of the menu items of the system menu have dimensions that are whole number multiples of the base cell.

17. A computer program product in accordance with claim 16, wherein the communicating the system menu further comprises identifying menu definitions that can be implemented by the identified CE device and only communicating those menu definitions that can be implemented by the CE device.

18. A computer program product in accordance with claim 17, wherein the identifying the system menu further comprises determining whether the system menu has been modified since the system menu was previously forwarded to the CE device, such that the communicating the identified system menu comprises communicating only modifications to menu definitions of the system menu when it is determined the system menu was modified since the system menu was previously forwarded to the CE device.

19. A computer program product in accordance with claim 15, wherein the identifying the system menu intended to be utilized by the CE device comprises identifying that the CE device is associated with a first group, and identifying the system menu corresponding to the first group.

20. A computer program product in accordance with claim 19, wherein the identifying the system menu further comprises identifying the CE device is associated with a second group, and selecting the system menu corresponding to both the first group and the second group.
